(19) United States
(12) Patent Application Publication
(10) Pub. No.: US 2026/0106342 A1
(43) Pub. Date: Apr. 16, 2026

(54) BATTERY CAP ASSEMBLY

(71) Applicant: GM GLOBAL TECHNOLOGY OPERATIONS LLC, Detroit, MI (US)

(72) Inventors: Hwanchul Kim, Dryden, MI (US); Shriram Santhanagopalan, Sylvania, OH (US)

(73) Assignee: GM GLOBAL TECHNOLOGY OPERATIONS LLC, Detroit, MI (US)

(21) Appl. No.: 18/915,305

(22) Filed: Oct. 14, 2024

(51) Int. Cl. H01M 50/536; B60L 50/64; H01M 50/15; H01M 50/474; H01M 50/477; H01M 50/55; H01M 50/586; H01M 50/595

(52) U.S. Cl. CPC H01M 50/536; B60L 50/64; H01M 50/15; H01M 50/474; H01M 50/477; H01M 50/55; H01M 50/586; H01M 50/595; H01M 2220/20

(57) ABSTRACT

Vehicles, battery assemblies, and methods for fabricating batteries are provided. A method for fabricating a battery includes arranging a plurality of foils associated with a plurality of electrodes of a battery cell in a stack, wherein the stack has an outer side surface; locating a cap assembly over the stack, wherein the cap assembly has an outer side surface, and wherein the cap assembly includes a conductive terminal in electrical connection with a battery cell tab, wherein an insulative plate is located between the battery cell tab and the conductive terminal; joining the battery cell tab to the plurality of foils; and adhering an insulative tape to the outer side surfaces of the stack and the cap assembly.

### INTRODUCTION

The disclosure relates generally to an assembly strategy for batteries, and more particularly to battery assemblies that provide for insulative bonding between battery caps and foils associated with electrodes of battery cells.

Lithium-ion and related batteries are being used in automotive and related transportation applications as a way to supplement, in the case of hybrid electric vehicles (HEVs), or supplant, in the case of purely electric vehicles (EVs), conventional internal combustion engines (ICEs). The ability to passively store energy from stationary and portable sources, as well as from recaptured kinetic energy provided by the vehicle and its components, makes such batteries ideal to serve as part of a propulsion system for cars, trucks, buses, motorcycles and related vehicular platforms. The flow of electric current to and from the individual cells (i.e., a single electrochemical unit) is such that when several such cells are combined into successively larger assemblies (such as modules and packs), the current or voltage can be increased to generate the desired power output. In the present context, larger module and pack assemblies are made up of one or more cells joined in series (for increased voltage), parallel (for increased current) or both, and may include additional structure to ensure proper installation and operation of these cells. One common vehicular form of the battery pack is known as a power battery, while another is known as an energy battery.

In one form, the individual cells that make up a battery pack are configured as rectangular (i.e., prismatic) cans that define a rigid outer housing known as a cell case. These types of cells are generally assembled into the power battery pack variant. Further, these cells may be placed in a facing arrangement (stacked like a deck of cards) along a stacking axis formed by the aligned parallel plate-like surfaces. Positive and negative terminals situated on one edge on the exterior of the housing of each cell are laterally-spaced from one another to act as electrical contacts for connection (via bus bar, for example) to an outside load or circuit. The battery cells may incorporate thin metal sheets as electrode substrates, or simply electrode sheets, to generate the flow of electric current. These electrode sheets incorporate an extension, i.e., tab, which extends outside of the cell pouch and is used to join the electrode sheet to conductors or bus bars made of copper metal or metal alloy or aluminum metal or metal alloy during battery assembly. Two types of tab materials are commonly used in battery construction: aluminum and copper. In some cases, the copper tabs and/or copper conductor may be coated with a thin layer of nickel to enhance corrosion resistance. In some cases, the aluminum tabs and/or aluminum conductor may have a thin anodization layer.

Ultrasonic metal welding has been used to join the thin tab materials to the conductor. Ultrasonic metal welding enables the joining of dissimilar metals and is capable of joining materials with significant differences in sheet thickness. Laser welding is another process that is used. This process allows for strong, consistent welds within small areas.

Generally, the process to join the tab materials to the conductor utilizes space below a cap assembly that seals the battery cells within the battery enclosure. It would be beneficial to provide a cap assembly that facilitates an insulative connection between the cap assembly and the stack of cells.

Accordingly, there is a need for devices and methods for fabricating or assembling a battery that provides for insulative connection between the cap assembly and the stack of cells. Furthermore, other desirable features and characteristics of the present disclosure will become apparent from the subsequent detailed description and the appended claims, taken in conjunction with the accompanying drawings and the foregoing technical field and background.

### SUMMARY

In an embodiment, a method for fabricating a battery includes arranging a plurality of foils associated with a plurality of electrodes of a battery cell in a stack, wherein the stack has an outer side surface; locating a cap assembly over the stack, wherein the cap assembly has an outer side surface, and wherein the cap assembly includes a conductive terminal in electrical connection with a battery cell tab, wherein an insulative plate is located between the battery cell tab and the conductive terminal; joining the battery cell tab to the plurality of foils; and adhering an insulative tape to the outer side surfaces of the stack and the cap assembly.

In certain embodiments of the method, joining the battery cell tab to the plurality of foils is performed before adhering the insulative tape to the outer side surfaces of the stack and the cap assembly.

In certain embodiments of the method, joining the battery cell tab to the plurality of foils is performed after adhering the insulative tape to the outer side surfaces of the stack and the cap assembly.

In certain embodiments of the method, joining the battery cell tab to the plurality of foils includes laser welding the battery cell tab to the plurality of foils.

In certain embodiments of the method, a first direction is defined by the connection from the conductive terminal to the battery cell tab; the insulative plate includes a main body extending between lateral edges in a second direction perpendicular to the first direction; the insulative plate further includes legs extending from the lateral edges to a distal end; and the legs form the outer side surface of the cap assembly.

In certain embodiments of the method, the legs are pivotably connected to the main body by hinges, and wherein the method includes moving the legs from an outward-extending configuration to a downward-extending configuration before adhering the insulative tape to the outer side surfaces of the stack and the cap assembly.

In certain embodiments, the method further includes attaching the legs to the main body before adhering the insulative tape to the outer side surfaces of the stack and the cap assembly.

In certain embodiments, the method further includes attaching the legs to the main body after joining the battery cell tab to the plurality of foils and before adhering the insulative tape to the outer side surfaces of the stack and the cap assembly.

In certain embodiments of the method, the legs are integral with the main body and are fixed in a downwardly-extending configuration In certain embodiments of the method, the outer side surface of the cap assembly has a height of at least 10 millimeters.

In another embodiment, a battery assembly is provided and includes a plurality of foils associated with a plurality of electrodes of a battery cell in a stack, wherein the stack has an outer side surface; a cap assembly over the stack, and an insulative tape adhered to the outer side surfaces of the stack and the cap assembly. The cap assembly includes a battery cell tab electrically joined to the plurality of foils; a conductive terminal in electrical connection with the battery cell tab; and an insulative plate between the battery cell tab and the conductive terminal, wherein the insulative plate includes a laterally-extending main body and downwardly-extending legs, and wherein the cap assembly has an outer side surface formed by the legs.

In certain embodiments of the battery assembly, the downwardly-extending legs are connected to the main body by a hinge.

In certain embodiments of the battery assembly, the downwardly-extending legs are connected to the main body by a friction fitting.

In certain embodiments of the battery assembly, the downwardly-extending legs are integral with the main body.

In certain embodiments, the battery assembly further includes a rigid enclosure, and the plurality of foils and the plurality of electrodes are positioned within the rigid enclosure.

In another embodiment, a vehicle is provided and includes an electric motor configured to provide motive torque; and a battery system operatively connected to the electric motor and operable to provide electrical power to the electric motor. The battery system includes an enclosure surrounding an internal space; a plurality of foils associated with a plurality of electrodes of a battery cell in a stack received within the internal space, wherein the stack has an outer side surface; a cap assembly over the stack, and an insulative tape adhered to the outer side surfaces of the stack and the cap assembly. The cap assembly includes a battery cell tab electrically joined to the plurality of foils; a conductive terminal in electrical connection with the battery cell tab; and an insulative plate between the battery cell tab and the conductive terminal. The insulative plate includes a laterally-extending main body and downwardly-extending legs, and the cap assembly has an outer side surface formed by the downwardly-extending legs.

In certain embodiments of the vehicle, the downwardly-extending legs are connected to the laterally-extending main body by a hinge.

In certain embodiments of the vehicle, the downwardly-extending legs are connected to the laterally-extending main body by a friction fitting.

In certain embodiments of the vehicle, the downwardly-extending legs are integral with the laterally-extending main body.

In certain embodiments of the vehicle, the insulative plate includes a cap plate having a first lateral length, and an insert having a second lateral length less than the first lateral length, and the insert forms a portion of the outer side surface of the cap assembly.

### DESCRIPTION OF THE DRAWINGS

The present disclosure will hereinafter be described in conjunction with the following drawing figures, wherein like numerals denote like elements, and wherein:

FIG. 1 is a schematic perspective view of an electric vehicle with a cut-away section to reveal a battery housed in a battery enclosure in accordance with exemplary embodiments.

FIG. 2 is a perspective view of the battery of FIG. 1, in accordance with exemplary embodiments.

FIG. 3 is a cross-sectional schematic view of the cap assembly of the battery of FIG. 2, in accordance with exemplary embodiments.

FIG. 4 is an overhead schematic view of the cap assembly of FIG. 3.

FIG. 5 is an end schematic view of the cap assembly of the battery of FIG. 2, in accordance with exemplary embodiments.

FIGS. 6 and 7 are cross-sectional schematic views of an embodiment of the insulative insert of the cap assembly of FIG. 5, shown in installed and un-installed configurations, in accordance with exemplary embodiments.

FIGS. 8 and 9 are cross-sectional schematic views of an embodiment of the insulative insert of the cap assembly of FIG. 5, shown in installed and un-installed configurations, in accordance with exemplary embodiments.

FIG. 10 is a perspective schematic view of an embodiment of the insulative insert of the cap assembly of FIG. 5, having a single configuration, in accordance with exemplary embodiments.

FIG. 11 is a flow chart illustrating a method for assembling a battery in accordance with certain embodiments.

### DETAILED DESCRIPTION

The following detailed description is merely exemplary in nature and is not intended to limit the application and uses of embodiments herein. Furthermore, there is no intention to be bound by any expressed or implied theory presented in the preceding introduction, summary or the following detailed description.

Embodiments of the present disclosure may be described herein in terms of functional and/or logical block components and various processing steps. Connecting lines shown in the various figures contained herein are intended to represent example functional relationships and/or physical couplings between the various elements. It should be noted that many alternative or additional functional relationships or physical connections may be present in an embodiment of the present disclosure.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

Embodiments herein provide for connecting a stack of electrodes and a battery cap assembly with an insulative tape to prevent damage to the prismatic cell, such as due to shorts, misalignment or other quality issues. In embodiments herein, the insulative tape is applied directly to an insulative insert located under and securely held by the conductive cap plate. Embodiments herein ensure that the connection between the stacked battery cell and cap assembly is fully covered with the insulative tape. Specifically, the interface between the stacked battery cell and the cap assembly is surrounded by insulative tape.

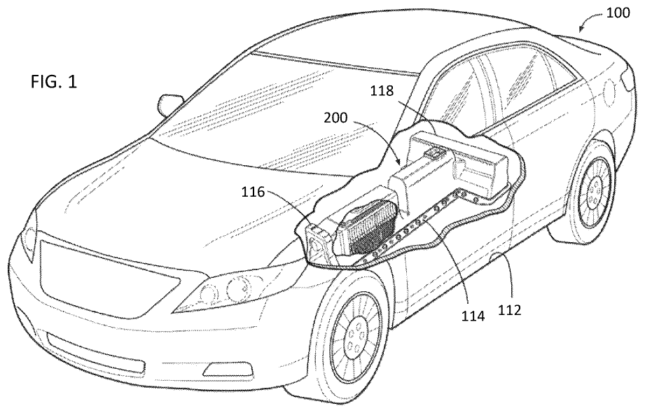

Referring to the drawings, wherein like reference numbers correspond to like or similar components wherever possible throughout the several figures, an electric vehicle 100 having a battery module 200, such as battery cell, or a plurality of battery cells in a battery assembly, is shown in FIG. 1. The term “battery” used alone herein may refer to a battery module, battery cell or cell stack. The term “battery pack” used alone may refer to a battery and the battery enclosure system the battery is housed within.

FIG. 1 illustrates the electric vehicle 100 as an automobile, such as any one of a number of different types of automobiles, such as, for example, a sedan, a wagon, a truck, sport utility vehicle (SUV), or the like. In certain implementations, the vehicle 100 may comprise a motorcycle or other land-based vehicle, such as a rail locomotive, or a non-land-based vehicle such as aircraft, spacecraft, watercraft, and so on, and/or one or more other types of mobile platforms (e.g., a robot and/or another mobile platform). In yet other implementations, the battery module 200 may instead be part of and/or coupled to any number of other types of platforms and/or other systems, moving or non-moving, such as a building, infrastructure, secondary use, home power, non-automotive, and/or other platforms and/or other systems.

The illustrated electric vehicle 100 includes a vehicle chassis 112. The battery module 200 is provided with a battery tray 114. The battery module 200 may attach to the battery tray 114, which in turn, may attach to the vehicle chassis 112 to secure the battery module 200 to the electric vehicle 100.

The electric vehicle 100 may also include a battery disconnect unit 116, which is connected to the battery 200 and provides electrical communication between the battery 200 and an electrical system (not shown) of the electric vehicle 10.

The battery module 200 is further provided with a battery cover 118 that extends over and around the battery 200. The battery cover 118 may protect the battery 200 from being damaged, as well as provide electrical insulation to the high voltage of the battery 200.

In exemplary embodiments, battery module 200 is an assembly of battery cells.

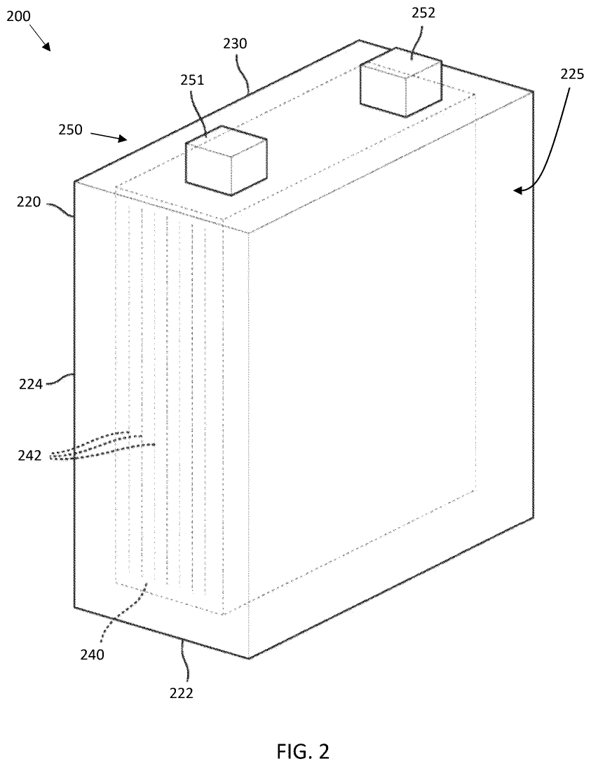

FIG. 2 schematically illustrates in perspective view of a battery cell 210 of the battery module 200 of FIG. 1. Specifically, FIG. 2 illustrates a prismatic battery cell 210.

The prismatic battery cell 210 is illustrated as including an outer case or enclosure 220 that surrounds and defines an internal space 225 within the enclosure 220. An exemplary outer enclosure 220 may be conductive. For example, the outer enclosure 220 may be metallic. In certain embodiments, the enclosure 220 is aluminum. The illustrated outer enclosure 220 is a rectangular polyhedron and includes relatively short side opposite faces 222 and relatively long side opposite faces 224.

As shown, the outer enclosure 220 may be formed with an open end, which is covered or closed by a cap 230. In certain embodiments, the cap 230 may be part of the enclosure 220. In certain embodiments, the cap 230 is conductive. For example, the cap 230 may be metallic, such as aluminum or aluminum alloy.

As shown, the battery cell 210 may include tabs or terminals 250, including a first tab or terminal 251, and an optional second tab or terminal 252. Each terminal 251, 252 may be in electrical connection with the battery cell components within the outer enclosure 220. In certain embodiments, each terminal 251, 252 is insulated from the cap 230.

In certain embodiments, the battery cell 210 includes an electrode assembly 240. As shown, the electrode assembly 240 is illustrated with dashed lines, indicating the electrode assembly 240 as a component of the prismatic battery cell 210 that is internal to the hard outer enclosure 220, i.e., located within the internal space 225. The electrode assembly 240 is illustrated with a plurality of electrode pair layers 242 arranged such that planar surfaces of the electrode pair layers 242 are perpendicular to the short faces 222. The electrode assembly 240 may be referred to as a stack 240 of electrode layers 242.

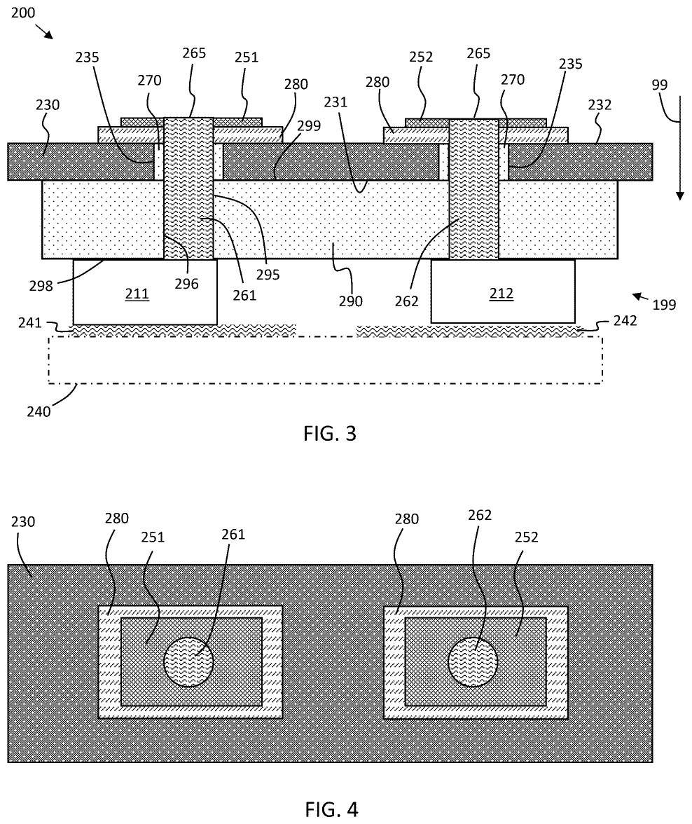

FIG. 3 is a cross-sectional schematic of the battery cell 210 of FIG. 2. In FIG. 3, certain internal components of the battery cell 210 are illustrated. FIG. 4 is an overhead view of the battery cell 210 of FIG. 3.

As shown in FIG. 3, the battery cell 210 includes a conductive first structure 211 and a conductive second structure 212. Each structure 211, 212 is in electrical connection with the electrode assembly 240 of FIG. 2. Structures 211, 212 may be referred to as welding plates.

In certain embodiments, structure 211 may be a cathode plate and structure 212 may be an anode plate. Alternatively, structure 211 may be an anode plate and structure 212 may be a cathode plate. Structures 211, 212 may be aluminum or copper. For example, an anode plate may be copper and a cathode plate may be aluminum.

Structure 211 may be electrically connected to a conductive rivet or connector 261, and structure 212 may be electrically connected to a conductive rivet or connector 262. For example, structure 211 may abut conductive rivet or connector 261, and structure 212 may abut conductive rivet or connector 262 as shown.

As shown in FIG. 3, the cap 230 has a top side 232 and an underside 231. Further, the cap 230 may be formed with openings 235 extending from the top side 232 to the underside 231. Further, each connector 261, 262 may extend through a respective opening 235 and through the cap 230 to a distal end 265. As shown, each connector 261, 262 extends in the direction indicated by arrow 99.

FIG. 3 further illustrates that the battery cell 210 is provided with an insulator spacer or sleeve 270 located in each opening 235. The insulator sleeves 270 insulate the cap 230 from each respective connector 261, 262.

Cross referencing FIGS. 3 and 4, the distal end 265 of connector 261 is electrically to terminal 251 and the distal end 265 of connector 262 is electrically to terminal 252. The battery cell 210 is provided with insulator plates 280 located over the cap 230. The insulator plates 280 insulate the cap 230 from each respective terminal 251, 252. Insulator plates 280 may be ceramic.

As shown in FIG. 3, an insulative insert 290 is provided between the cap 230 and the structures 211, 212. In certain embodiments, insert 290 is formed from thermoplastic resin. For example, insert 290 may be comprised of polypropylene.

As shown in FIG. 3, insert 290 contacts the underside 231 of the cap 230. As shown, insert 290 also contacts cathode/anode structures 211, 212. In certain embodiments, insert 290 is compressed between cap 230 and cathode/anode structures 211, 212. Insulative insert 290 may insulate the enclosure 220 from the structures 211 and 212 and may insulate the enclosure 220 from the connectors 261 and 262. Specifically, insulative insert 290 may provide an ohmic resistance between the cap 230 and the electrode assembly 240 and/or internal bussing circuit.

In the embodiment of FIG. 3, insulative insert 290 may be a unitary piece. For example, insert 290 may be formed from a thermoplastic resin. Insert 290 may be formed by injection molding.

In the embodiment of FIG. 3, insulative insert 290 has a bottom surface 298 that abuts and directly contacts the structure 211. Further, region 291 has a top surface 299 that abuts and directly contacts the cap 230 (and the insulator sleeve 270).

In FIG. 3, insulative insert 290 is formed with openings 295 and has inner surfaces 296 that define the openings 295. As shown, the connectors 261 and 262 extend through the openings 295 such that the inner surfaces 296 contact the connectors 261 and 262.

In certain embodiments, the cap 230, insulative insert 290, sleeves 270, insulator plates 280, connectors 261 and 262, terminals 251, 252, and cathode and anode structures 211, 212 may be pre-assembly and provided as a cap assembly 199.

During assembly of a battery, the pre-assembled cap assembly 199 may be located over electrode foils 241 in electrical connection with the electrode assembly 240 and/or with an internal bussing circuit in electrical connection with the electrode assembly 240. Then, the cathode and anode structures 211, 212 may be joined to the electrode foil or electrode foils 241 in electrical connection with the electrode assembly 240 and/or with an internal bussing circuit in electrical connection with the electrode assembly 240.

For example, a welding process, such as laser welding, may be used to join the cathode and anode structures 211, 212 in electrical connections to the electrode assembly 240, such as through connection to electrode foils 241.

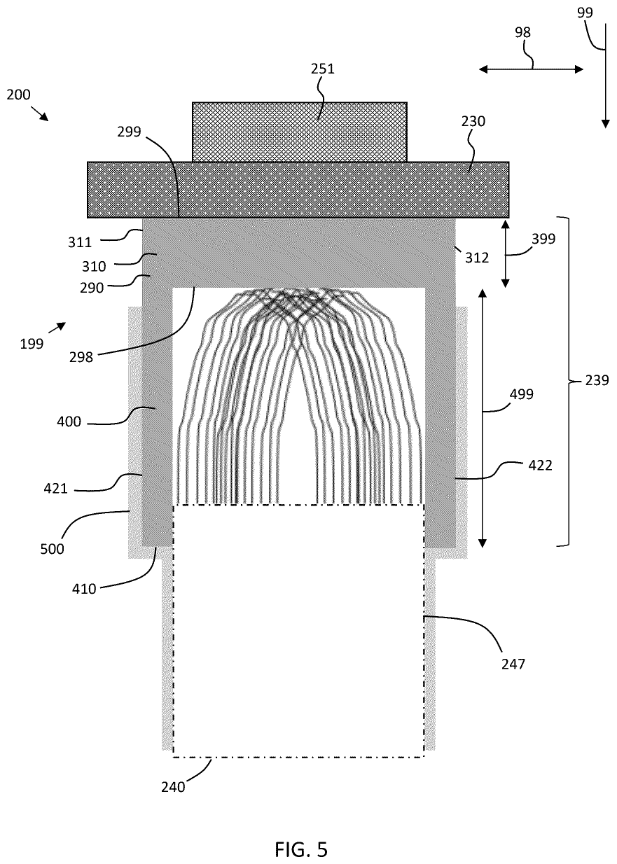

FIG. 5 is an end view of an embodiment of assembly 200 for facilitating application of an insulative tape 500 to structurally connect the stack 240 of electrode layers 242 to the cap assembly 199. Specifically, the insulative tape 500 may be used to structurally connect the insulative insert 290 and an outer surface 247 of the stack 240 of electrode layers. In certain embodiments, the insulative tape 500 is a polypropylene adhesive tape.

As shown in FIG. 5, the insulative insert 290 includes a laterally-extending main body 310. Specifically, main body 310 extends laterally in the direction of arrow 98, substantially perpendicular to the vertical direction 99, between outer lateral edges 311 and 312. Main body 310 may form the bottom surface 298 and the top surface 299 of the insulative insert 290. As shown, bottom surface 298 and top surface 299 may each be perpendicular to vertical direction 99. Further, bottom surface 298 and top surface may be distanced from one another by a main body thickness or main body length 399.

Further, the insulative insert 290 includes legs 400 that extend downwardly, in the direction of arrow 99, from the main body 310 to distal ends or edges 410. Each leg 400 may have a length 499 from the bottom surface 298 to the distal end 410. As shown, the downward-extending legs 400 may form outer side surfaces 421 and 422.

In certain embodiments, outer side surface 421 is continuous with outer lateral edge 311 and outer side surface 422 is continuous with outer lateral edge 312. Thus, the insulative insert 290 is formed with outer side surfaces 239 have a length equal to the sum of length 399 and length 499. In certain embodiments, the length of each outer side surface 239 is from ten (10) to twelve (12) millimeters.

In embodiments herein, an insulative adhesive tape 500 is adhered to the outer side surfaces 421 and 422 of the legs 400 of the insulative insert 290 and to the outer surface 247 of the stack 240 of electrode layers as shown. The insulative adhesive tape 500 may also be adhered to the outer lateral edges 311 and 312.

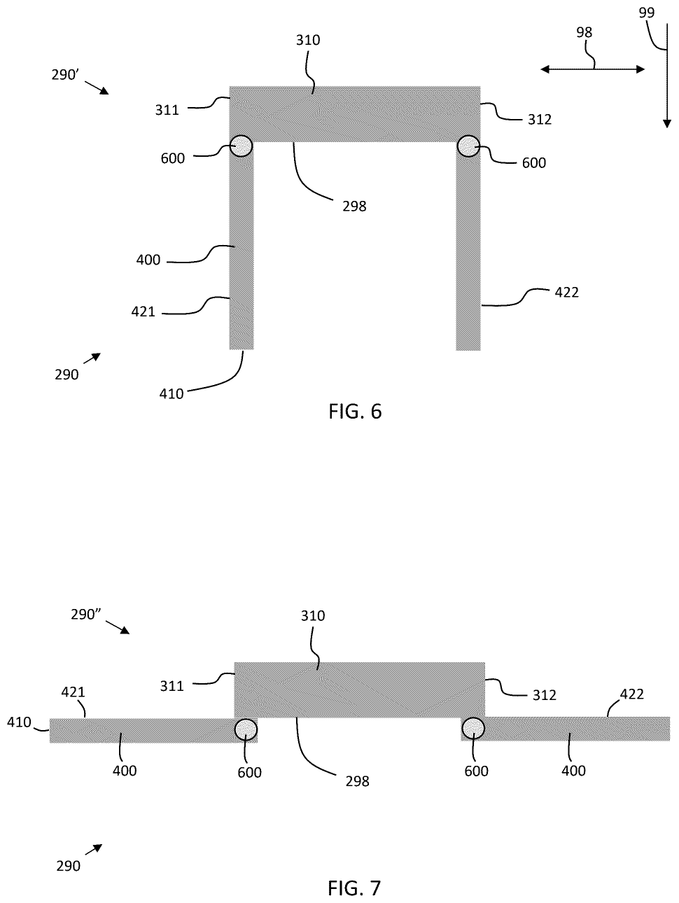

FIGS. 6 and 7 illustrate an embodiment of an insulative insert 290 in which the legs 400 are pivotably mounted to the main body 310 by hinges 600. FIG. 6 illustrates the insulative insert 290 in an installed configuration 290′ in which the legs 400 extend downward from the main body 310 as described above in relation to FIG. 5.

In FIG. 7, the legs 400 are pivoted outward to extend laterally in a non-installed configuration 290″.

In FIGS. 6 and 7, the main body 310 and legs 400 are distinct components that are pivotably fixed together by hinges 600 to provide for movement of the legs 400 between the configurations 290′ and 290″.

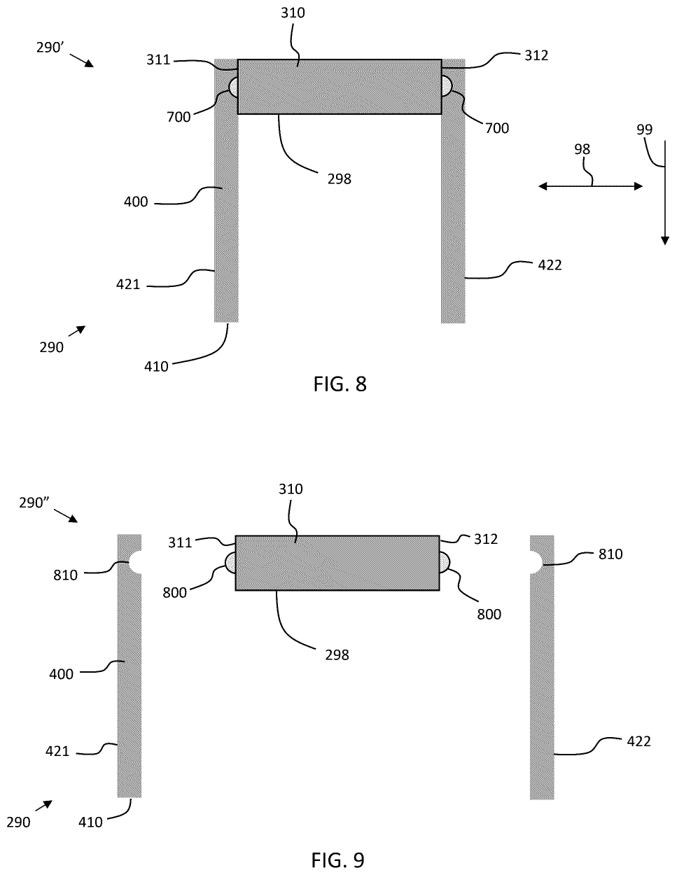

FIGS. 8 and 9 illustrate an embodiment of an insulative insert 290 in which the legs 400 are detachable and attachable to the to the main body 310 by connective features 800. FIG. 8 illustrates the insulative insert 290 in an installed configuration 290′ in which the legs 400 are attached to the main body 310 and extend downward from the main body 310 as described above in relation to FIG. 5.

In FIG. 9, the legs 400 are detached from the main body 310 in a non-installed configuration 290″.

In FIGS. 8 and 9, the main body 310 and legs 400 are distinct components that may be selected attached together and detached from one another by connective features 800. As shown, the connective features 800 may be formed on the outer lateral edges 311 and 312 of the main body 310 and may be received in, or cooperate with, a mating feature 810 formed on the legs 400. Alternatively, the connective feature 800 may be formed on the legs 400 and the mating feature 810 may by formed on the main body 310. In either case, the connective features 800 and mating features 810 provide for selectively engaging the legs 400 to the main body 310 to form the insulative insert 290 with the installed configuration 290′ when desired.

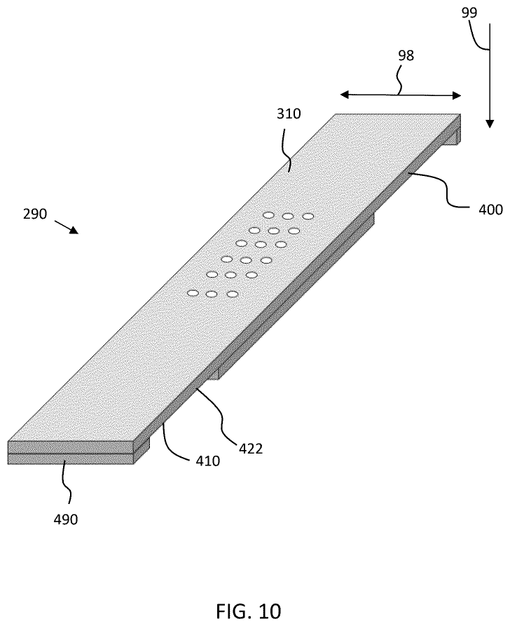

FIG. 10 illustrates an embodiment in which the main body 310 and legs 400 are integral. Further, the legs 400 are interconnected by end walls 490. As shown, the legs 400 are fixed in a downwardly-extending configuration.

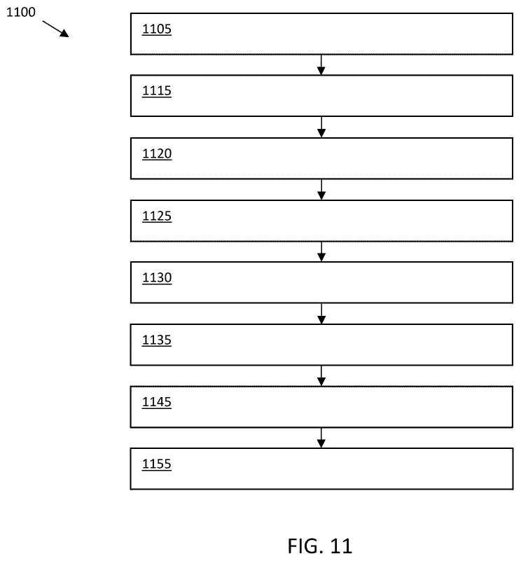

Referring now to FIG. 11, a method 1100 for fabricating or assembling a battery is provided.

Method 1100 includes, at operation 1105, arranging a plurality of foils associated with a plurality of electrodes of a battery cell in a stack.

Method 1100 includes, at operation 1115, locating a cap assembly over the stack. In embodiments in which the cap assembly has a non-installed configuration and an installed configuration, operation 1115 includes providing the cap assembly in the non-installed configuration.

In certain embodiments, method 1100 includes applying insulative tape to the stacked battery cells at optional operation 1120 to hold the stack battery cells.

Method 1100 includes, at operation 1125, joining the battery cell tab to the plurality of foils. For example, operation 1125 may include laser welding the battery cell tab to the plurality of foils.

In certain embodiments, method 1100 includes applying insulative tape to anode/cathode plates at optional operation 1130.

Method 1100 further includes, at operation 1135, moving the cap assembly, and specifically, the insulative insert, from the non-installed configuration to the installed configuration. For example, operation 1135 may include pivoting hinged legs from a laterally-outward extending configuration to a downwardly-extending configuration. Or, operation 1135 may include attached previously detached legs to the main body of the insulative insert.

In embodiments in which the insulative insert has a single configuration operation 1135 may not be performed.

Method 1100 also includes, at operation 1145, adhering insulative tape to the outer side surfaces of the stack and the cap assembly, such as to the legs or to the legs and main body of the insulative insert, to cover entirely, i.e., enclose, the interface between the stack and the cap assembly.

Method 1100 may also include finishing enclosing the battery cell in the enclosure at operation 1155. For example, the battery cap may be sealed to the enclosure.

While FIG. 11 illustrates operations 1105-1155 in a described order, method 1100 may be performed in any suitable order of operations. For example, the legs may be moved from the non-installed configuration to the installed configuration before or after joining the battery cell tab to the foils. Further, the tape may be adhered to the stack and cap assembly before or after joining the battery cell tab to the foils.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for fabricating a battery comprising:
arranging a plurality of foils associated with a plurality of electrodes of a battery cell in a stack, wherein the stack has an outer side surface;
locating a cap assembly over the stack, wherein the cap assembly has an outer side surface, and wherein the cap assembly comprises a conductive terminal in electrical connection with a battery cell tab, wherein an insulative plate is located between the battery cell tab and the conductive terminal;
joining the battery cell tab to the plurality of foils; and
adhering an insulative tape to the outer side surfaces of the stack and the cap assembly.

2. The method of claim 1, wherein joining the battery cell tab to the plurality of foils is performed before adhering the insulative tape to the outer side surfaces of the stack and the cap assembly.

3. The method of claim 1, wherein joining the battery cell tab to the plurality of foils is performed after adhering the insulative tape to the outer side surfaces of the stack and the cap assembly.

4. The method of claim 1, wherein joining the battery cell tab to the plurality of foils comprises laser welding the battery cell tab to the plurality of foils.

5. The method of claim 1, wherein:
a first direction is defined by the connection from the conductive terminal to the battery cell tab;
the insulative plate includes a main body extending between lateral edges in a second direction perpendicular to the first direction;
the insulative plate further comprises legs extending from the lateral edges to a distal end; and
the legs form the outer side surface of the cap assembly.

6. The method of claim 5, wherein the legs are pivotably connected to the main body by hinges, and wherein the method comprises moving the legs from an outward-extending configuration to a downward-extending configuration before adhering the insulative tape to the outer side surfaces of the stack and the cap assembly.

7. The method of claim 5, further comprising attaching the legs to the main body before adhering the insulative tape to the outer side surfaces of the stack and the cap assembly.

8. The method of claim 5, further comprising attaching the legs to the main body after joining the battery cell tab to the plurality of foils and before adhering the insulative tape to the outer side surfaces of the stack and the cap assembly.

9. The method of claim 5, wherein the legs are integral with the main body and are fixed in a downwardly-extending configuration.

10. The method of claim 1, wherein the outer side surface of the cap assembly has a height of at least 10 millimeters.

11. A battery assembly comprising:
a plurality of foils associated with a plurality of electrodes of a battery cell in a stack, wherein the stack has an outer side surface;
a cap assembly over the stack, wherein the cap assembly comprises:
a battery cell tab electrically joined to the plurality of foils;
a conductive terminal in electrical connection with the battery cell tab; and
an insulative plate between the battery cell tab and the conductive terminal, wherein the insulative plate includes a laterally-extending main body and downwardly-extending legs, and wherein the cap assembly has an outer side surface formed by the legs; and
an insulative tape adhered to the outer side surfaces of the stack and the cap assembly.

12. The battery assembly of claim 11, wherein the downwardly-extending legs are connected to the main body by a hinge.

13. The battery assembly of claim 11, wherein the downwardly-extending legs are connected to the main body by a friction fitting.

14. The battery assembly of claim 11, wherein the downwardly-extending legs are integral with the main body.

15. The battery assembly of claim 11, further comprising a rigid enclosure, wherein the plurality of foils and the plurality of electrodes are positioned within the rigid enclosure.

16. A vehicle comprising:
an electric motor configured to provide motive torque; and
a battery system operatively connected to the electric motor and operable to provide electrical power to the electric motor, wherein the battery system comprises:
an enclosure surrounding an internal space;
a plurality of foils associated with a plurality of electrodes of a battery cell in a stack received within the internal space, wherein the stack has an outer side surface;
a cap assembly over the stack, wherein the cap assembly comprises:
a battery cell tab electrically joined to the plurality of foils;
a conductive terminal in electrical connection with the battery cell tab; and
an insulative plate between the battery cell tab and the conductive terminal, wherein the insulative plate includes a laterally-extending main body and downwardly-extending legs, and wherein the cap assembly has an outer side surface formed by the downwardly-extending legs; and
an insulative tape adhered to the outer side surfaces of the stack and the cap assembly.

17. The vehicle of claim 16, wherein the downwardly-extending legs are connected to the laterally-extending main body by a hinge.

18. The vehicle of claim 16, wherein the downwardly-extending legs are connected to the laterally-extending main body by a friction fitting.

19. The vehicle of claim 16, wherein the downwardly-extending legs are integral with the laterally-extending main body.

20. The vehicle of claim 16, wherein the insulative plate includes a cap plate having a first lateral length, and an insert having a second lateral length less than the first lateral length, and wherein the insert forms a portion of the outer side surface of the cap assembly.
